(19) United States
(12) Patent Application Publication
(10) Pub. No.: US 2008/0149269 A1
(43) Pub. Date: Jun. 26, 2008

(54) ADHESIVE TAPE AND METHOD FOR ADHERING THE ADHESIVE TAPE

(75) Inventor: Keiichi SUZUKI, Okaza-shi (JP)

Correspondence Address: SUGHRUE MION, PLLC, 2100 Pennsylvania Avenue, N.W., Washington, DC, 20037, US

(73) Assignee: Seiko Epson Corporation, Tokyo (JP)

(21) Appl. No.: 11/958,797

(22) Filed: Dec. 18, 2007

(30) Foreign Application Priority Data
Dec. 21, 2006 (JP) 2006-344728

(51) Int. Cl. B32B 3/10; B32B 37/02

(52) U.S. Cl. 156/312; 428/131

(57) ABSTRACT

An adhesive tape interposed between a lens and at least one of a pair of chucks of an edging machine includes: a cutout extending from a periphery toward a center portion thereof.

The entire disclosure of Japanese Patent Application No. 2006-344728, filed Dec. 21, 2006, is expressly incorporated by reference herein.

### BACKGROUND

1. Technical Field

The present invention relates to an adhesive tape and a method for adhering the adhesive tape on a lens which are used in edging.

2. Related Art

In a spectacle retail shop, a circumference of a circular spectacle lens is ground into a shape to be accommodated in a spectacle frame on a spectacle retailer (so-called edging). In the edging, a processing center of a front surface or a rear surface of the spectacle lens is sucked and held by chucks of an edging machine. Alternatively, the processing center of the spectacle lens is sandwiched and pressed from both of the front and rear surfaces. In these states, an edge of the spectacle lens is ground with a grinding stone while frictionally holding the lens.

Some of the spectacle lenses are provided thereon with an anti-dirt layer containing fluorine-containing silane compound that exhibits excellent antipollution and abrasion resistance with sustainability. However, when the anti-dirt layer containing fluorine-containing silane compound as a main component is provided on a lens surface of the spectacle lens, the lens surface held by the chuck becomes too slippery. Accordingly, the lens may be slipped by a grinding pressure of the grinding stone with respect to the chuck, causing positional displacement (axial displacement) of the lens. As a result, the spectacle lens cannot be accurately edged.

To direct the problem, a method for adhering an adhesive tape having strong adhesion with respect to the anti-dirt layer on the lens surface on which the chuck of the edging machine abuts is known (JP-A-2004-249454).

In the method, a flat adhesive tape for edging is adhered on either of a convex surface or a concave surface of the spectacle lens or on both of the convex and concave surfaces of the lens so as to cover the processing center.

In the related art example shown in JP-A-2004-249454, the flat adhesive tape is deformed so as to fit to the convex surface and the like of the spectacle lens to be adhered and fixed on the lens on a lens-side adhesive layer provided on a surface of the tape.

However, when the spectacle lens is a plus lens having high curvature of the convex surface or a minus lens having high curvature of the concave surface, the followability of the adhesive tape to the lens surface will be deteriorated. When the adhesive tape does not sufficiently follow the lens surface, the adhesive tape may wrinkle, reducing an adhesion area of the adhesive tape against the lens surface. Further, when water is poured on the spectacle lens to cool the lens or to remove grinding material in the edging, the water may enter from a wrinkled portion of the adhesive tape.

As described above, the existing flat adhesive tape wrinkles when being adhered on the spectacle lens surface, which lowers adhesion of the adhesive tape with respect to the spectacle lens.

### SUMMARY

An advantage of some aspects of the invention is to provide an adhesive tape exhibiting constant adhesion on a lens irrespective of curvature of the lens and a method for adhering the adhesive tape.

An adhesive tape according to an aspect of the invention is interposed between a lens and at least one of a pair of chucks of an edging machine and includes a cutout extending from a periphery toward a center portion thereof.

In the arrangement, a measurement value of the adhesion of the adhesive tape may preferably be 4 gf (0.0392 N) or more when a polyethylene terephthalate plate that is surface-processed with fluorine-modified silicone parting agent is used as a test plate in a 180-degree peel-back adhesion testing method defined in JIS-Z0237 “Testing methods of pressure-sensitive adhesive tapes and sheets”.

With the arrangement, when the adhesive tape is pressed to fit to the curvature of a surface of the lens, a circumferential portion of the adhesive tape is deformed to come close (i.e. the diameter shrinks) in a circumferential direction. However, since the cutout in the adhesive tape can absorb the deformation, the adhesive tape does not wrinkle.

Accordingly, irrespective of the curvature of the lens surface, the adhesive tape can be adhered on the lens surface without wrinkling. Hence, even when the lens is watered in edging to cool the lens or to remove grinding material, the water does not enter from a gap between the adhesive tape and the lens surface, thereby preventing decrease in adhesion of the adhesive tape with respect to the lens.

In the adhesive tape, the width of the cutout may preferably become broader from the center portion toward the periphery.

With the arrangement, since the cutout has a substantially sector shape with the center portion as the top, the adhesive tape can be adhered on the lens surface with no gap when the curvature of the lens surface is unique from the center portion to the periphery thereof.

In the adhesive tape, the cutout may be preferably provided in plural.

In the arrangement, the top angle of each cutout becomes smaller in accordance with increase in the number of the cutouts.

With the arrangement, by providing the cutout in plural, the entire adhesive tape can sufficiently follow the curvature of the lens surface. Specifically, when only a single cutout is provided, the adhesive tape can be properly adhered on a lens surface of high curvature but may wrinkle on the opposite side of the cutout on a lens surface of low curvature. However, by providing the cutout in plural as in the arrangement so as to, for instance, oppose each other around the center portion, deformation generated in adhering the adhesive tape can be evenly absorbed even when the curvature of the lens surface is low. Thus, the adhesive tape can be adhered without wrinkling.

In the adhesive tape, three marks may be preferably provided on the lens. The three marks may include: a center point provided on a center portion of the lens; and lateral-end points provided on both sides of the center point. The cutout may be provided to allow visual recognition of the lateral-end points.

Herein, the marks are so-called alignment marks used as horizontal reference in edging the lens.

In this arrangement, since the lateral-end points can be visually checked through the cutouts, the adhesive tape can be accurately adhered on the lens surface so as not to cover the marks provided on the lens surface even when, for example, the adhesive tape is opaque due to a foam layer contained therein. In other words, since the cutouts prevent wrinkle and simultaneously allow recognition of the lateral-end points, it is unnecessary to provide adhesive tapes for each purpose.

The adhesive tape may further include a center hole to allow recognition of the center point, the center hole being spaced from an edge of the cutout near the center of the adhesive tape.

In this arrangement, since the center hole is provided to allow recognition of the center point (the mark) provided on the lens surface, the adhesive tape can be adhered on the lens surface so as not to cover the center point provided on the lens surface even when, for instance, the adhesive tape is opaque due to a foam layer contained therein.

In addition, although the adhesive tape is divided into a plurality of pieces when the center hole and the cutouts are continuous, the adhesive tape is provided as one-piece component when the cutouts are formed with a distance from the center hole as in the arrangement, thereby facilitating adhering process of the adhesive tape.

A method for adhering the above-described adhesive tape on a lens according to an aspect of the invention includes: pressing a center portion of the adhesive tape on a center of the lens; and subsequently pressing the adhesive tape on the lens from the center portion toward a periphery of the adhesive tape.

In the arrangement, initially the center portion of the adhesive tape is positioned to be pressed on the center portion of the lens. Subsequently, the adhesive tape is pressed on the lens surface from the center portion to the periphery thereof, so that the adhesive tape can be accurately adhered on the lens surface.

### BRIEF DESCRIPTION OF THE DRAWINGS

The invention will be described with reference to the accompanying drawings, wherein like numbers reference like elements.

FIG. 1A shows a spectacle lens and an adhesive tape applied on the spectacle lens according to an exemplary embodiment of the invention;

FIG. 1B also shows the spectacle lens and the adhesive tape applied on the spectacle lens according to the exemplary embodiment;

FIG. 2 is a cross section schematically showing a spectacle-lens fixing portion of the exemplary embodiment;

FIG. 3 is an exploded view schematically showing the spectacle-lens fixing portion of the exemplary embodiment;

FIG. 4 is a cross section schematically showing another spectacle-lens fixing portion;

FIG. 5 is a plan view showing an example of the adhesive tape of the exemplary embodiment;

FIG. 6 is a plan view showing another example of the adhesive tape of the exemplary embodiment;

FIG. 7 is a plan view showing still another example of the adhesive tape of the exemplary embodiment;

FIG. 8 is a plan view showing further example of the adhesive tape of the exemplary embodiment;

FIG. 9 is a plan view showing still further example of the adhesive tape of the exemplary embodiment;

FIG. 10 is a plan view showing still further example of the adhesive tape of the exemplary embodiment;

FIG. 11 is a plan view showing still further example of the adhesive tape of the exemplary embodiment;

FIG. 12 is a plan view showing still further example of the adhesive tape of the exemplary embodiment;

FIG. 13 is a plan view showing still further example of the adhesive tape of the exemplary embodiment;

FIG. 14 is a plan view showing still further example of the adhesive tape of the exemplary embodiment;

FIG. 15 is a perspective view showing the adhesive tape adhered on release paper according to the exemplary embodiment; and

FIG. 16 is a cross section showing the adhesive tape adhered on the release paper according to the exemplary embodiment.

### DESCRIPTION OF EXEMPLARY EMBODIMENT(S)

An exemplary embodiment of the invention will be described below with reference to the drawings. Note that the exemplary embodiment is an example where an adhesive tape according to the invention is applied to a spectacle lens.

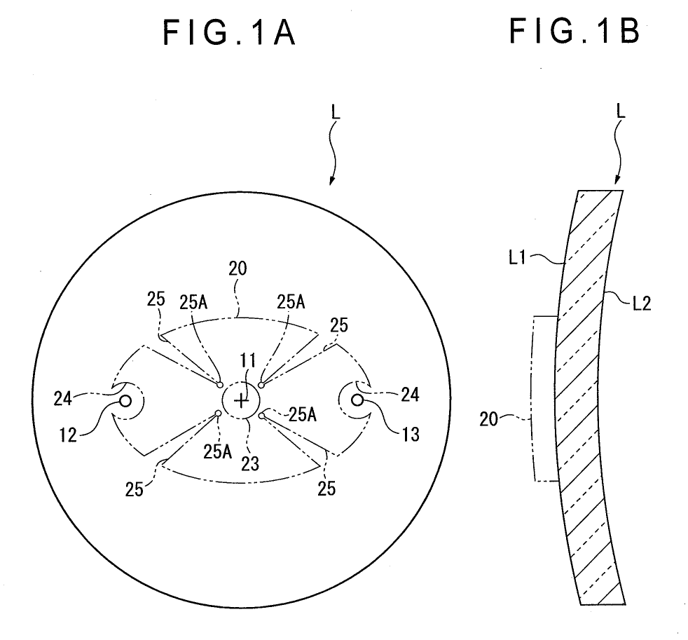

FIG. 1A is a plan view and FIG. 1B is a cross section, each showing a spectacle lens L on which the adhesive tape of the exemplary embodiment is adhered.

The spectacle lens L of the exemplary embodiment is a meniscus lens of which one surface (the outer surface) is a convex surface L1 and the other surface (the inner surface: a surface located on the side of an eyeball of a user) is a concave surface L2. The spectacle lens L is a lens before being edged. In plan view, the lens L is substantially circular. The diameter of the lens L is about 75 mm. The spectacle lens L is, for instance, an astigmatic lens.

A base material of the spectacle lens L may be either inorganic glass or plastics as long as the base material is transparent. The plastics include diethylene glycol bisallyl carbonate (CR-39) resin, polyurethane resin, thiourethane resin, polycarbonate resin, acrylic resin and the like.

An outermost surface of the spectacle lens L is anti-dirt processed to prevent dirt from sticking on the lens or to easily wipe the dirt when stuck on the lens. In other words, on the outermost surface of the spectacle lens L, an anti-dirt layer having water repellency or oil repellency is formed. When the base material of the spectacle lens L is glass, the anti-dirt layer may be preferably formed after an anti-reflection layer is provided on the spectacle lens L. When the base material is plastic, the anti-dirt layer may be preferably formed after providing a hard coating layer or after providing a hard coating layer and an anti-reflection layer.

The anti-dirt layer may preferably contain fluorine-containing silane compound as a main component in order to reduce surface tension. For example, the fluorine-containing silane compound shown in the following general formula (1) can be used.

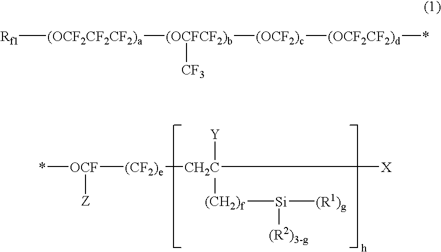

In the general formula (1), R_{f1} is a straight-chained or branched perfluoroalkyl group, which preferably is CF₃—, C₂F₅—, C₃F₇—. X represents hydrogen, bromine or iodine. Y represents hydrogen or lower alkyl group. Z represents fluorine or trifluoromethyl group. R¹ represents hydroxyl group or hydrolysable group. R² represents hydrogen or monovalent hydrocarbon group. a, b, c, d and e each represent 0 or an integer of 1 or more. a+b+c+d+e equals 1 or more. Parenthesized repeat units with a, b, c, d or e may be in any order in the formula. f represents 0, 1 or 2. g represents 1, 2 or 3. h represents an integer of 1 or more.

The above-mentioned fluorine-containing silane compound may be a compound shown by a general formula (2).

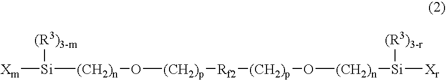

In the general formula (2), R_{f2} includes a unit shown by a formula: —(CₖF₂ₖ)O—(k in the general formula (2) represents an integer of 1 to 6), which represents a divalent group having an unbranched straight-chained perfluoropolyalkylene ether structure. R³ represents a monovalent hydrocarbon group having 1 to 8 carbon atoms. X represents a hydrolyzable group or a halogen atom. p represents 0, 1 or 2. n represents an integer of 1 to 5. m and r each represent 2 or 3.

As shown in FIG. 1, marks are printed on the anti-dirt layer formed on the convex surface L1 of the spectacle lens L as alignment marks serving as horizontal reference used in the later-described edging. The marks include one center point 11 indicating an optical center and two horizontal reference marks 12, 13 (lateral-end points) indicating a horizontal direction of the spectacle lens L that is set to a predetermined astigmatic axis based on a prescription.

The center point 11 is provided as a cross of two straight lines printed at an optical center position of the spectacle lens L. The horizontal reference marks 12, 13 are printed as circles on a horizontal line passing the center point 11.

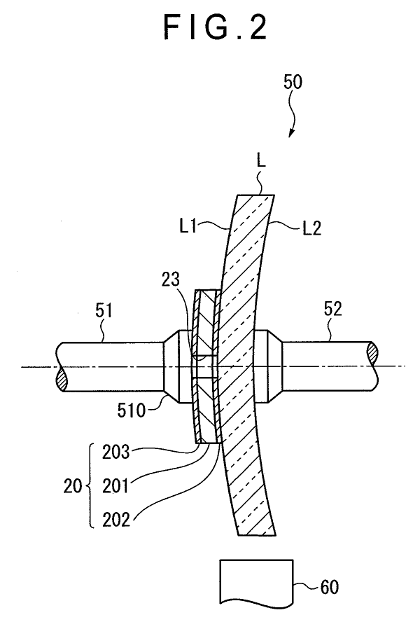

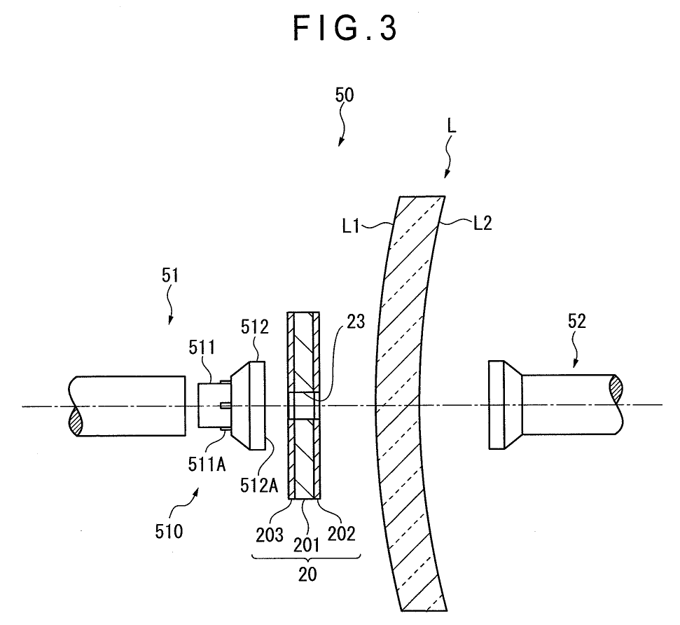

FIG. 2 is a schematic cross section of a spectacle-lens fixing portion showing the spectacle lens L to be edged. FIG. 3 is an exploded view schematically showing a fixing structure of the spectacle lens L. Note that, in FIGS. 2 and 3, dimensions or proportions of the components are different from actual sizes for the convenience of description.

In FIG. 2, the spectacle lens L is processed using an edging machine 50. The edging machine 50 includes a pair of fixing devices (a chuck 51 (one fixing device) and a chuck 52 (the other fixing device)), a grinding stone 60 abutted to a periphery of the spectacle lens L while being rotated in order to grind the periphery, a clamp axis, a driver, a drive controller for controlling the driver, a storage storing frame data and the like and a water-supply nozzle (the last five components not shown).

A lens holder 510 made of synthetic resin is mounted on an end of the chuck 51 to chuck (fix) the spectacle lens L from one side via an adhesive tape 20. An elastic body made of rubber or the like is provided to an end of the chuck 52 to be abutted to the concave surface L2 of the spectacle lens L, thereby fixing the spectacle lens L. The spectacle lens L is pressed and fixed by the chucks 51 and 52 with the convex surface L1 opposed to the chuck 51 and with a center axis of the fixing devices (the chucks 51 and 52) positioned at a processing center of the spectacle lens L.

As shown in FIG. 3, the lens holder 510 mounted on the end of the chuck 51 of the edging machine 50 includes a cylindrical attachment 511 positioned and fixed at the position and a flanged lens holding section 512 connected to the attachment 511.

On an outer circumferential surface of the attachment 511, projections 511A that are fitted in a main body of the chuck 51 when the lens holder 510 is mounted to the main body of the chuck 51 are formed. On an end of the lens holding section 512, a cup-like lens holding surface 512A is formed.

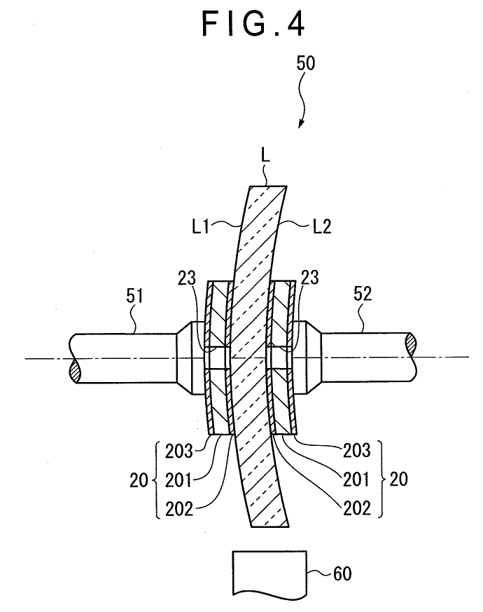

The adhesive tape 20 is interposed between the convex surface L1 of the spectacle lens L and the chuck 51 so as to cover the processing center of the spectacle lens L. According to the exemplary embodiment, as shown in FIG. 4, the adhesive tape 20 may be provided on both sides of the spectacle lens L.

The adhesive tape 20 includes a base layer 201, a lens-side adhesive layer 202 provided on the base layer 201 on the side of the lens and a chuck-side adhesive layer 203 provided on the base layer 201 on the side of the chuck 51.

The base layer 201 of the adhesive tape 20 may be made of: polyolefin resins such as polyethylene and polypropylene; polyester such as polystyrene and polyethylene terephthalate; thermoplastic resins such as polyvinyl acetate, ethylene-vinyl acetate, ABS, polycarbonate, polyvinyl chloride resin, polyamide, polyimide, acetate, polytetrafluoroethylene; thermosetting resin such as epoxy resin; rubber-based resin such as soft and hard rubber; or resin containing reinforcement material for the above-mentioned materials such as fiber material.

Note that, when the base layer 201 is provided as a foam, material having elasticity capable of being compressed by 10% or more in a direction perpendicular to the lens surface may be preferably used to improve the followability against the curved surface. Alternatively, even when the base layer 201 is foam, the entire base layer 201 may not be foam. The base layer 201 may be a laminated structure of a foam layer and a non-foam layer.

Regarding the strength of the base layer 201, tensile strength (tensile yield strength or tensile breaking strength) defined in JIS-K7127 “Plastics—Determination of tensile properties—Part 3: Test conditions for films and sheets (“Ferrous Materials&Metallurgy” by Japanese Standards Association, issued on Apr. 12, 1989) may be preferably 1 kgf/mm² (9.8 N/mm²) or more. The base layer 201 preferably has tensile elasticity satisfying: 1 kgf/mm²≦Em≦450 kgf/mm² (9.8 N/mm²≦Em≦4410 N/mm²).

Adhesion of the lens-side adhesive layer 202 needs to be sufficient to be attachable to the anti-dirt layer of low surface tension. In a 180-degree peel-back adhesion testing method defined in JIS-Z0237 “Testing methods of pressure-sensitive adhesive tapes and sheets”, the adhesion needs to be 4 gf (0.0392 N) or more or preferably to be 6 gf (0.0588 N) or more when a polyethylene terephthalate plate that is surface-processed with fluorine-modified silicone parting agent is used as a test plate.

Refer to JP-A-2004-249454 for the 180-degree peel-back adhesion testing method defined in JIS-Z0237 and the testing method for calculating the adhesion of the adhesive tape 20.

When the adhesive tape 20 has a planar shape protruding from a predetermined lens shape into which the spectacle lens L is to be ground, the adhesive tape 20 may be peeled from the protruding portion by the grinding stone 60, machining water or the like during the edging. Hence, the adhesive tape 20 preferably has an outer profile smaller than that of the predetermined lens shape.

The adhesive tape 20 of the exemplary embodiment includes: the base layer 201 made of chloroprene-rubber foam (neoprene foam) having a thickness of approximately 0.8 mm; the lens-side adhesive layer 202 that is provided on one side of the base layer 201, is made of acrylic adhesion material and has a thickness of approximately 20 μm; and the chuck-side adhesive layer 203 that is provided on the other side of the base layer 201 and is made of rubber adhesion material.

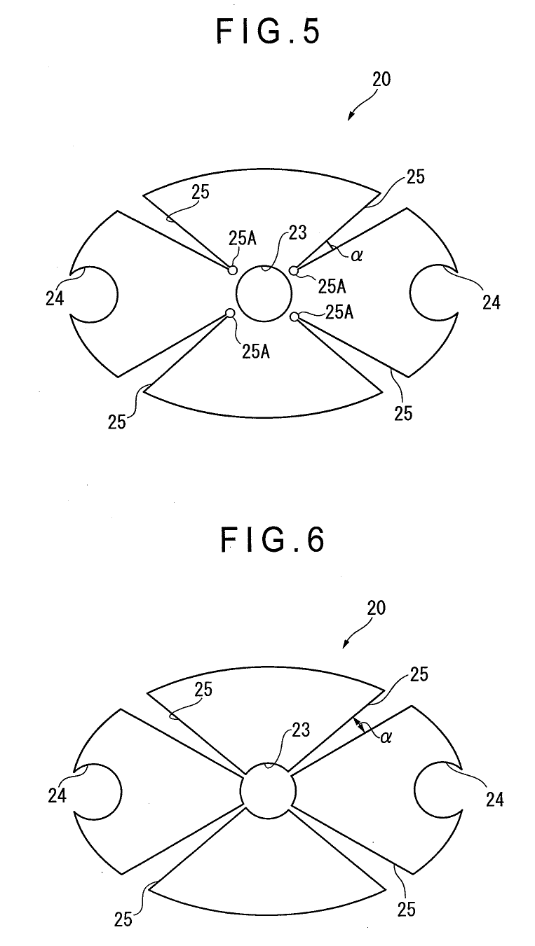

Next, referring to FIGS. 5 to 14, the planar shape of the adhesive tape 20 of the exemplary embodiment will be described. FIGS. 5 to 14 each show the adhesive tape 20.

FIG. 5 is a plan view showing an example of the adhesive tape 20.

In FIG. 5, the adhesive tape 20 is an ellipse having predetermined dimensions (e.g., a height of 25 mm and a width of 40 mm). Substantially at the center of the ellipse, a circular center hole 23 penetrating the adhesive tape 20 from a front side to a rear side is provided. On an outer circumferential portion in a width direction of the ellipse, substantially circular mark-recognition openings 24 are provided. Cutouts 25 extend from the periphery toward a center portion of the ellipse.

The center hole 23 allows visual recognition of the center point 11 when the adhesive tape 20 is adhered on the convex surface L1 of the spectacle lens L. The mark-recognition openings 24 allow visual recognition of the horizontal reference marks 12, 13. Shapes and sizes of the center hole 23 and the mark-recognition openings 24 are not limited to the above-mentioned ones as long as the marks can be viewed.

When the base material of the adhesive tape 20 is transparent, the mark-recognition openings 24 are not necessary.

The four cutouts 25 are disposed to be substantially equally spaced from each other, each cutout 25 extending from the center portion of the adhesive tape 20 with a width broadening from the center portion of the adhesive tape 20 toward the periphery thereof.

The cutouts 25 each have a substantially sector shape of which top has an angle α in order to make slant sides of the sector shape to abut to each other when the adhesive tape 20 is adhered on the curved surface of the spectacle lens L.

At the top of the cutout 25, an R portion 25A is formed in a substantially arc shape.

In the exemplary embodiment shown in FIG. 5, the center hole 23 is spaced by a predetermined distance from the R portion that is an edge of the cutout 25 on the center side.

FIG. 6 is a plan view showing another example of the adhesive tape 20 which is the same as that of FIG. 5 except that the center hole 23 is continuously communicated with the center side edge of the cutout 25.

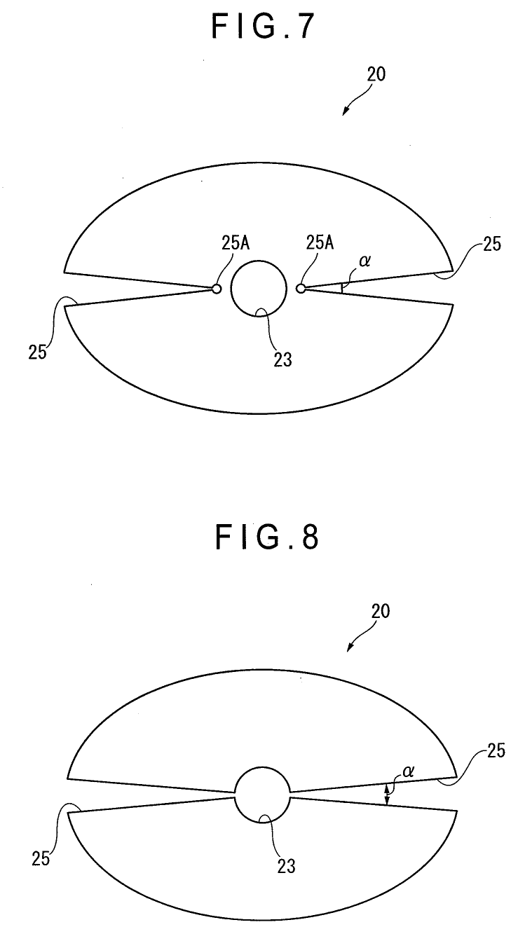

FIG. 7 is another plan view showing still another example of the adhesive tape 20.

The adhesive tape 20 in FIG. 7 is an ellipse similar to the adhesive tape 20 in FIG. 5, in which the center hole 23 is provided substantially at the center of the ellipse and the cutouts 25 also serving as the mark-recognition openings are provided on the outer circumferential portion in the width direction of the ellipse, the cutouts 25 extending from the periphery toward the center portion.

The two cutouts 25 are disposed at opposing positions, each cutout 25 extending from the center portion of the adhesive tape 20 with a width broadening from the center portion of the adhesive tape 20 toward the periphery thereof to exhibit a sector shape.

Also in the adhesive tape 20 in FIG. 7, the angle α of each cutout 25 is set so as to allow the slant sides of the sector shape to abut to each other when the adhesive tape 20 is adhered on the curved surface of the spectacle lens L.

In the exemplary embodiment shown in FIG. 7, the center hole 23 is spaced by a predetermined distance from the R portion that is an edge of the cutout 25 on the center side.

FIG. 8 is a plan view showing another example of the adhesive tape 20 which is the same as that of FIG. 7 except that the center hole 23 is continuously communicated with the center side edge of the cutout 25 to provide a continuous gap.

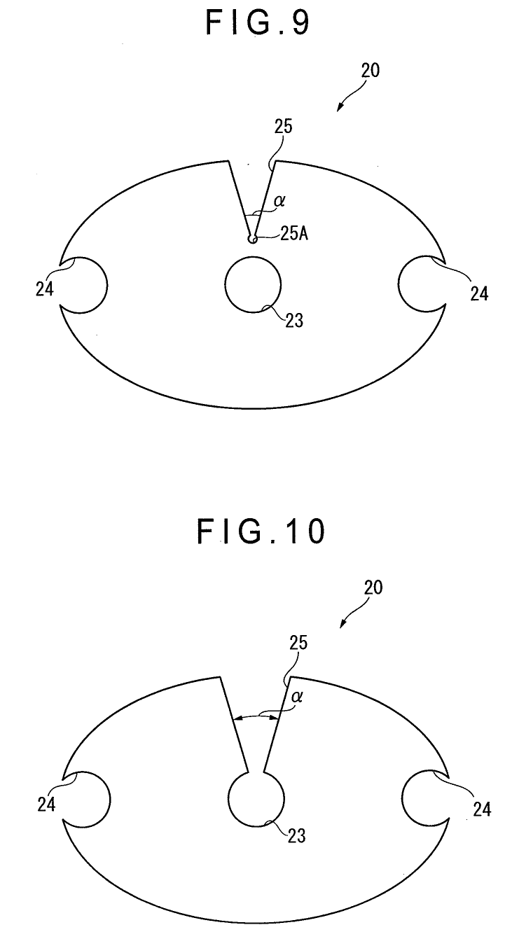

FIG. 9 is another plan view showing another example of the adhesive tape 20.

In FIG. 9, the adhesive tape 20 is an ellipse similar to the adhesive tape 20 of FIG. 5, in which the center hole 23 is provided substantially at the center of the ellipse; the mark-recognition openings 24 are provided on the outer circumferential portion in the width direction of the ellipse; and the cutout 25 extends from the periphery toward the center portion.

The single cutout 25 extends from the center portion of the adhesive tape 20 with a width broadening from the center portion of the adhesive tape 20 toward the periphery thereof to exhibit a sector shape.

Also in the adhesive tape 20 in FIG. 9, the angle α of each cutout 25 is set so as to allow the slant sides of the sector shape to abut to each other when the adhesive tape 20 is adhered on the curved surface of the spectacle lens L.

In the exemplary embodiment shown in FIG. 9, the center hole 23 is spaced by a predetermined distance from the R portion that is an edge of the cutout 25 on the center side.

FIG. 10 is a plan view showing another example of the adhesive tape 20 which is the same as that of FIG. 9 except that the center hole 23 is continuously communicated with the center side edge of the cutout 25.

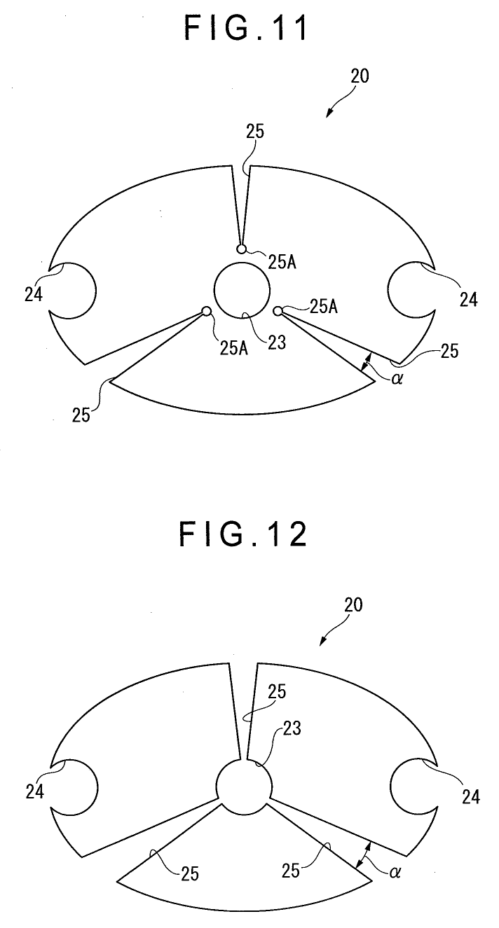

FIG. 11 is another plan view showing another example of the adhesive tape 20.

The adhesive tape 20 in FIG. 11 is an ellipse similar to the adhesive tape 20 in FIG. 5, in which: the center hole 23 is provided substantially at the center of the ellipse; the two mark-recognition openings 24 are provided on the outer circumferential portion; and the cutouts 25 extend from the periphery toward the center portion.

The cutouts includes three cutouts 25 that are disposed at opposing positions, each cutout 25 extending from the center portion of the adhesive tape 20 with a width broadening from the center portion of the adhesive tape 20 to the periphery thereof to exhibit a sector shape.

Also in the adhesive tape 20 in FIG. 11, the angle α of each cutout 25 is set so as to allow the slant sides of the sector shape to abut to each other when the adhesive tape 20 is adhered on the curved surface of the spectacle lens L.

In the exemplary embodiment shown in FIG. 11, the center hole 23 is spaced by a predetermined distance from the R portion that is an edge of the cutout 25 on the center side.

FIG. 12 is a plan view showing another example of the adhesive tape 20 which is the same as that of FIG. 11 except that the center hole 23 is continuously communicated with the center side edge of the cutout 25.

In the adhesive tapes 20 shown in FIGS. 5 to 12, the top angle α of the cutout 25 becomes smaller in accordance with increase in the number of the cutouts 25.

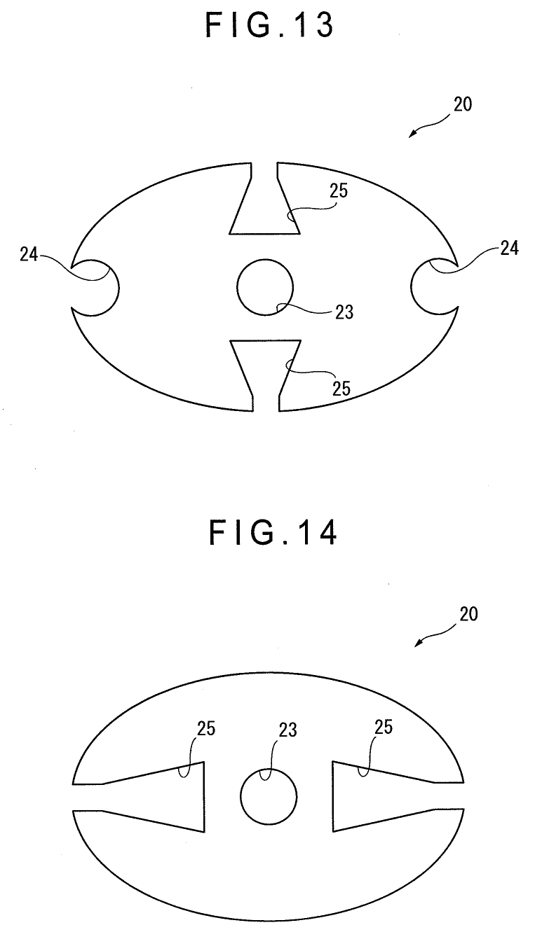

FIG. 13 is another plan view showing another example of the adhesive tape 20.

The adhesive tape 20 in FIG. 13 is an ellipse similar to the adhesive tape 20 in FIG. 5, in which the center hole 23 is provided substantially at the center of the ellipse; the two mark-recognition openings 24 are provided on the outer circumferential portion; and the cutouts 25 extend from the periphery toward the center portion.

The two cutouts 25 are provided at opposing positions, each cutout 25 having an inverted sector shape of which width on an open side is small and of which bottom side (a width on the center portion side) is large.

In the adhesive tape 20 in FIG. 13, the open side of the cutout 25 is dimensioned such that the open side is closed when the adhesive tape 20 is adhered on the curved surface of the spectacle lens L.

In the exemplary embodiment shown in FIG. 13, the center hole 23 is spaced by a predetermined distance from an edge of the cutout 25 on the center side.

FIG. 14 is a plan view showing another example of the adhesive tape 20 in which the cutouts 25 are provided at positions different from those of the exemplary embodiment shown in FIG. 13. In FIG. 14, the cutouts 25 also serve as the mark-recognition openings.

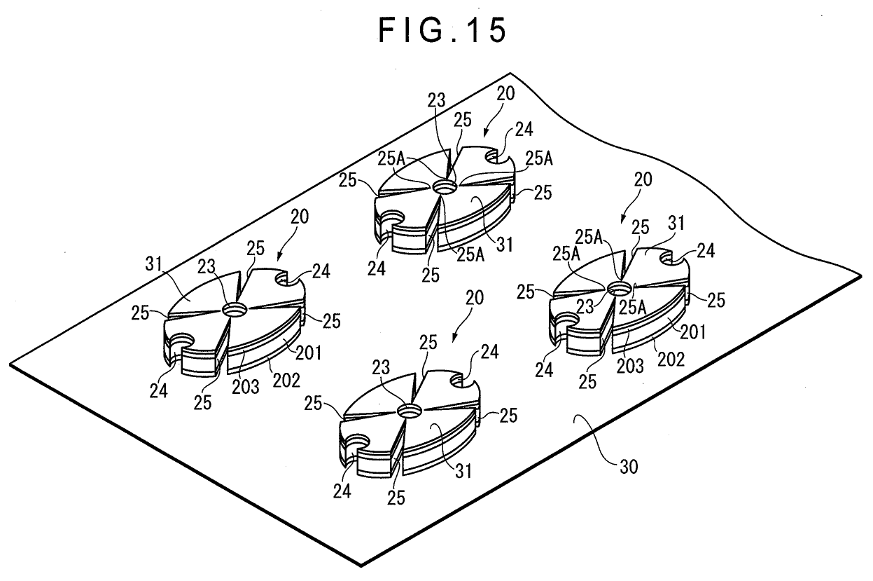

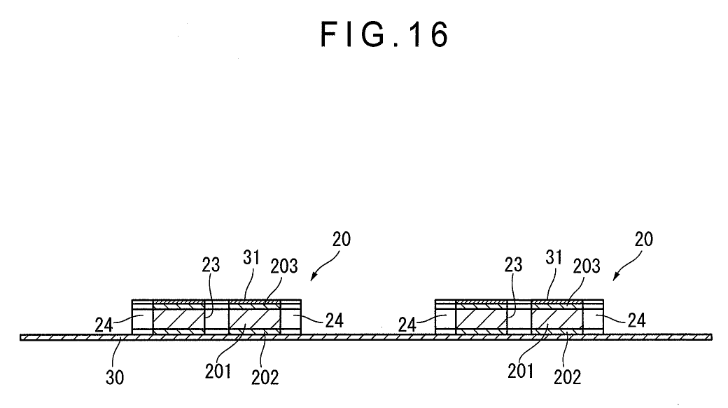

The adhesive tapes 20 having the above-described arrangements are stored in a manner that a plurality of adhesive tapes 20 are adhered in advance on a piece of the release paper 30. FIG. 15 is a perspective view showing the adhesive tapes 20 of FIG. 5 adhered on the release paper 30 and FIG. 16 is a cross section thereof. Note that, in FIGS. 15 and 16, the layers of each adhesive tape 20 are illustrated thick for easy understanding of the structure of the adhesive tape 20.

In FIGS. 15 and 16, the adhesive layers 202 and 203 of the adhesive tape 20 are respectively adhered on the release paper 30 and 31 both in a releasable manner. The release paper 31 has the same planar shape as that of the adhesive tape 20.

Adhesion between the release paper 30 and the adhesive layer 202 is smaller than the adhesion between the adhesive layer 202 and the base layer 201 and than the adhesion between the adhesive layer 203 and the base layer 201. Similarly, adhesion between the release paper 31 and the adhesive layer 203 is smaller than the adhesion between the adhesive layer 202 and the base layer 201 and than the adhesion between the adhesive layer 203 and the base layer 201.

To manufacture the adhesive tapes 20 adhered on the release paper 30 and 31, sheets of the adhesive layer 202, the base layer 201 and the adhesive layer 203 all having the same size as that of the release paper 30 are laminated and then a sheet of the release paper 31 is initially laminated on the adhesive layer 203. Subsequently, a cutter (not shown) having the planar shape of the adhesive tape 20 is pressed on the release paper 31 to cut the release paper 31, the adhesive layer 203, the base layer 201 and the adhesive layer 202 except for the release paper 30 that remains uncut.

Next, the edging of the spectacle lens L will be described with reference to FIGS. 1 to 3.

Adhering Step

Firstly, the adhesive tape 20 is adhered on the concave surface L1 of the spectacle lens L on which the anti-dirt layer is formed. Specifically, one adhesive tape 20 is released from the release paper 30 to be adhered on the concave surface L1 such that the centers of the center hole 23 and the mark-recognition openings 24 of the adhesive tape 20 are positioned substantially on the centers of the marks (the center point 11 and the horizontal reference marks 12, 13) and the marks are not covered by the adhesive tape 20 (see FIG. 1). Accordingly, the center portion of the adhesive tape 20 is initially pressed on the center portion of the spectacle lens L and then the adhesive tape 20 is pressed on the spectacle lens L from the center portion toward the periphery thereof.

Attachment Step Next, the lens holder 510 is attached on the adhesive tape 20 adhered on the concave surface L1 of the spectacle lens L in a manner described below.

In the attachment step, firstly the spectacle lens L with the concave surface L1 on which the adhesive tape 20 is adhered is fixed on a known centering device with the adhesive tape 20 facing upward. In other words, the spectacle lens L is leveled.

The centering device, which is also called a blocker, recognizes the marks (i.e. the center point 11 indicating the optical center and the two horizontal reference marks 12, 13 indicating the horizontal direction of the lens, see FIG. 1) printed on the convex surface L1 of the spectacle lens L to fix the spectacle lens L in a predetermined vertical posture.

Next, the release paper 31 is released from the adhesive tape 20 adhered on the spectacle lens L fixed to the centering device. Then the lens holder 510 is adhered on the adhesive layer 203 of the adhesive tape 20.

Mounting Step

Subsequently, the spectacle lens L held by the lens holder 510 via the adhesive tape 20 is mounted to the chuck 51 (one of the fixing devices) of the edging machine 50. Specifically, the lens holder 510 is inserted into the main body of the chuck 51 such that the four projections 511A provided on the outer circumferential surface of the attachment 511 fit in dented portions (not shown) formed inside the main body of the chuck 51.

Fixing Step

Next, with the lens holder 510 attached to the main body of the chuck 51, the chuck 52 (the other of the fixing devices) of the edging machine 50 is advanced by the clamp axis to be abutted to the concave surface L2 of the spectacle lens L. Accordingly, the spectacle lens L is sandwiched by the chuck 51 and the chuck 52 and fixed therebetween (see FIG. 2). In other words, the adhesive tape 20 is interposed between the spectacle lens L and the chuck 51.

Grinding Step

Then, the rotating grinding stone 60 is abutted to the periphery of the spectacle lens L fixed between the chucks 51 and 52 to grind the spectacle lens L into a predetermined shape.

The spectacle lens L is ground into the predetermined shape that fits in a spectacle frame based on frame data stored in advance in the storage. During the grinding, water is supplied from the water-supply nozzle toward a circumferential portion of the spectacle lens L to remove heat and to wash grinding powder both generated in the grinding.

According to the exemplary embodiment, the following advantages can be obtained.

(1) Since the adhesive tape 20 is provided with at least one cutout 25 extending from the of the periphery toward the center portion, the adhesive tape 20 can be adhered on the lens surface without wrinkling irrespective of the curvature of the lens surface. Hence, even when being watered in edging to cool the spectacle lens L or to remove grinding material, the adhesion of the adhesive tape 20 with respect to the spectacle lens L is not lowered.

(2) Since the cutout 25 has the substantially sector shape with a width broadening from the center portion toward the periphery of the tape 20 to exhibit a substantially sector shape, the adhesive tape 20 can be fitly adhered on the lens surface.

(3) When at least one cutout 25 is provided, the entire adhesive tape 20 can sufficiently follow the curvature of the lens surface, thereby reliably preventing the adhesive tape 20 from being wrinkled.

(4) Since the adhesive tape 20 has a larger area than an abutting area of the adhesive tape 20 on the chuck 51, the chuck 51 and the spectacle lens L can sufficiently fit together, thereby stably fixing the lens in edging.

(5) Since the adhesive tape 20 is provided with the center hole 23 and the mark-recognition openings 24 to recognize the marks provided on the lens surface, the adhesive tape 20 itself can be easily adhered on the spectacle lens L and the spectacle lens L can be easily chucked in edging.

(6) When the adhesive tape 20 is opaque due to a foam layer contained therein, neglect ion of peeling the adhesive tape 20 can be securely prevented.

(7) Since the adhesive tape 20 is stored after being adhered on the release paper 30 in a releasable manner and used after being released from the release paper 30, the adhesive tape 20 can be easily handled. In particular, when the center hole 23 and the cutout 25 are continuous, dividing the adhesive tape 20 into a plurality of small pieces, the whole adhesive tape 20 can be retained organized in a proper shape on the release paper 30.

(8) In the exemplary embodiments where the center hole 23 are spaced from the center side edge of the cutout 25 by a predetermined distance, the adhesive tape 20 is a single piece, which is easy to handle.

(9) Since the R portion 25A is formed on the top of each cutout 25, the adhesive tape 20 is not torn apart by the force locally applied on the top of the cutout 25.

(10) In order to adhere the adhesive tape 20 on the spectacle lens L, initially the center portion of the adhesive tape 20 is positioned to be pressed on the center portion of the spectacle lens L. Subsequently, the adhesive tape 20 is pressed on the lens surface from the center portion to the periphery thereof, so that the adhesive tape 20 can be accurately adhered on the lens surface.

Note that the above-described embodiments are exemplary, so that the invention is not limited thereto. It should be appreciated that modifications or improvements are contained in the scope of the invention as long as an object or an advantage can be obtained. Specific structures, shapes and the like to implement the invention may be alternatively determined in the scope of an object and an advantage of the invention.

For example, although the adhesive tape 20 has the laminated structure of the adhesive layer 202, the base layer 201 and the adhesive layer 203 in the above exemplary embodiments, only one of the adhesive layers 202, 203 may be employed or the adhesive tape 20 may have a five-layer structure of the adhesive layer 202, a base layer, an adhesive layer, the base layer 201 and the adhesive layer 203. In the one-side adhesive tape only having either the layer 202 or 203, a lens lock tape is used to adhere a leap cup.

Further, the outer profile of the adhesive tape 20 in plan view is not limited to the ellipse but may be a circle, triangle, rectangle or pentagon.

### EXAMPLES

Next, the invention will be described below in more detail by means of examples. However, the scope of the invention is not restricted by the description below.

Specifically, as shown below, after the adhesive tape was adhered on the convex surface of a predetermined spectacle lens, the spectacle lens was chucked by a pair of chucks to be edged. In the edging, axial displacement of the spectacle lens was observed. Note that, the examples are basically same as the above-described exemplary embodiments. Hence, description on details unnecessary to be repeated will be omitted herein.

(1) Lens-Edging Spectacle Lens:

A spectacle plastic lens (Seiko Lucious manufactured by SEIKO EPSON CORPORATION) having degrees of S=+3.50 D and C=+0.50 D was used.

Note that the lens surface was provided with the anti-dirt layer containing, as a main component, fluorine-containing silane compound shown in the above-mentioned general formula (1) or (2). The anti-dirt layer was formed by vacuum vapor deposition in which an amount of anti-dirt agent was increased by 20% than a normal amount in order to clarify effects of preventing axial displacement of the tape. A curvature radius of the convex surface of the lens was 86.57 mm.

(2) Adhesive Tape:

The three types of adhesive tapes below were used as edging adhesive tapes.

(2-1) Adhesive Tape 1

base layer:
thickness: 100 μm
material: polyethylene

lens-side adhesive layer:
thickness: 20 μm
material: acryl

chuck-side adhesive layer: not provided

(2-2) Adhesive Tape 2

base layer:
thickness: 160 μm
material: polyethylene

lens-side adhesive layer:
thickness: 20 μm
material: acryl

chuck-side adhesive layer:
thickness: 20 μm
material: rubber

(2-3) Adhesive Tape 3

base layer:
thickness: 500 μm
material: sheet containing neoprene foam

lens-side adhesive layer:
thickness: 20 μm
material: acryl

chuck-side adhesive layer:
thickness: 20 μm
material: rubber

Since the adhesive tape 1 was one-side adhesive, a lens lock tape was used to adhere a leap cup on the adhesive tape 1 and then the lens was set to an edging machine. On the other hand, since the adhesive tapes 2, 3 were both-side adhesive, the leap cup was directly adhered on the adhesive tapes 2, 3.

(3) Cutouts in Adhesive Tapes

(3-1) Example A (the Exemplary Embodiment Shown in FIG. 5)

Four cutouts were provided such that each distance between the tops of the cutouts and the center hole 23 was 1.5 mm.

(3-2) Example B (the Exemplary Embodiment Shown in FIG. 6)

Four cutouts were provided such that each distance between the tops of the cutouts and the center hole 23 was 0 mm (i.e. the cutouts 25 and the center hole 23 were continuous).

(3-3) Comparison (No Cutout was Provided)

(4) Testing Method

The evaluation was conducted by observing whether or not axial displacement occurred due to sliding of a chuck portion (a portion to fix the lens on the axis of the edging machine) with respect to the lens surface during grinding of the spectacle lens into a predetermined frame shape by the edging machine. Procedure will be shown below.

An elongated-rectangle spectacle frame having a high horizontal-to-vertical ratio was prepared to be used as a reference frame.

Firstly, a to-be-tested lens was set to a lens meter with the astigmatic axis thereof aligned at 180 degrees and then the three marks were provided. The three marks were for clearly viewing the optical center and the astigmatic axis of the lens.

Next, the edging adhesive tapes 1 to 3 were adhered on the convex surfaces of the spectacle lenses.

The spectacle lenses were set to a lens-fixing device (a lens blocker). The spectacle lenses were each fixed such that the astigmatic axis thereof was at 180 degrees. The leap cup was set to an arm of the blocker to be adhered at a predetermined position.

As mentioned above, the leap cup was adhered on the adhesive tape 1 via the lens lock tape while the leap cut was directly adhered on the adhesive tape 2, 3.

The above lenses were set to the edging machine (LE-8080 manufactured by NIDEK CO., LTD.) to be edged based on the above-mentioned frame data.

The edged lenses were accommodated in the reference frame and the astigmatic axis displacement was measured by the lens meter.

Thus, twenty lenses were edged and a percentage of lenses of which axial displacement exceeded a predetermined allowable range was calculated. The allowable range of the axial displacement was set ±2 degrees or less.

Results of the axial displacement evaluation are as shown in Table 1.

TABLE 1

| | Adhesive tape | | |
|---|---|---|---|
| Cutout | 1 | 2 | 3 |
| Example A | 0% | 0% | 0% |
| Example B | 0% | 0% | 0% |
| Comparison | 20% | 30% | 20% |

In all of the adhesive tapes 1, 2 and 3 in Examples A and B where the cutouts were provided, no axial displacement occurred (0%).

On the other hand, in Comparison where no cutout was provided, the axial displacement occurred at a percentage of 20 to 30%.

The testing results clearly prove the effects of the adhesive tapes provided with the cutouts. Specifically, due to the improved followability to the curved surface of the adhesive tape, even the high-degree plus lens having the curved surface of low curvature (which was used in the test) can be accurately edged without causing serious displacement.

The invention can be applied to edging of a spectacle lens and the like.

What is claimed is:

1. An adhesive tape interposed between a lens and at least one of a pair of chucks of an edging machine, comprising:
a cutout extending from a periphery toward a center portion thereof.

2. The adhesive tape according to claim 1, wherein
the width of the cutout becomes broader from the center portion toward the periphery.

3. The adhesive tape according to claim 1, wherein
the cutout is provided in plural.

4. The adhesive tape according to claim 1, wherein
three marks are provided on the lens, the three marks including: a center point provided on a center portion of the lens; and lateral-end points provided on both sides of the center point, and
the cutout is provided to allow visual recognition of the lateral-end points.

5. The adhesive tape according to claim 4, further comprising:
a center hole to allow recognition of the center point, the center hole being spaced from an edge of the cutout near the center of the adhesive tape.

6. A method for adhering an adhesive tape on a lens, the adhesive tape being interposed between a lens and at least one of a pair of chucks of an edging machine and including a cutout extending from a periphery toward a center portion thereof, comprising:
pressing a center portion of the adhesive tape on a center of the lens; and
subsequently pressing the adhesive tape on the lens from the center portion toward a periphery of the adhesive tape.
